(19) United States
(12) Patent Application Publication
(10) Pub. No.: US 2019/0086065 A1
(43) Pub. Date: Mar. 21, 2019

(54) CONTROL APPARATUS OF LIGHT SOURCE AND VEHICLE LAMP USING THE SAME

(71) Applicant: STANLEY ELECTRIC CO., LTD., Tokyo (JP)

(72) Inventor: Yoichi HIROSE, Tokyo (JP)

(73) Assignee: STANLEY ELECTRIC CO., LTD., Tokyo (JP)

(21) Appl. No.: 16/137,171

(22) Filed: Sep. 20, 2018

(30) Foreign Application Priority Data
Sep. 21, 2017 (JP) 2017-181225

(51) Int. Cl. F21V 23/00; H05B 33/08; B60Q 1/00; B60Q 1/26

(52) U.S. Cl. CPC F21V 23/003; B60Q 1/2696; B60Q 1/0094; H05B 33/0815

(57) ABSTRACT

A vehicle lamp using a control apparatus for controlling on-off states of a light source having a plurality of light-emitting chips connected in series, can include switching devices each connected in parallel with a respective one of the light-emitting chips, a control circuit controlling each of on-off actions of the switching devices, and a current supply unit. The control apparatus can control the light-emitting chips so as not to exceed a supply capability the current supply unit applying a driving current to the light-emitting chips, and also can allow the switching devices to decrease than the number of the light-emitting chips. The vehicle lamp can include a system controller to appropriately control the control apparatus. Thus, the present invention can provide the vehicle lamp using the control apparatus, which can provide preferable light distribution patterns with reliability and a simple structure as usage of the vehicle lamp.

This application claims the priority benefit under 35 U.S.C. § 119 of Japanese Patent Application No. 2017-181225 filed on Sep. 21, 2017, which is hereby incorporated in its entirety by reference.

### BACKGROUND

### 1. Field

The present invention relates to control apparatuses for controlling on-off actions of a light source provided with light-emitting chips connected in series and vehicle lamps using the control apparatus, which may selectively drive each of the light-emitting chips. Thus, the vehicle lamp can provide preferable light distribution patterns with a simple structure as a headlight, a cornering lamp, a rear lamp, etc.

### 2. Description of the Related Art

In vehicle lamps, a headlight, which includes such functions that control variable light distribution patterns in accordance with circumstances such as o e chides around the subject vehicle, pedestrians, etc. and which includes such functions that project light in a turning direction when the subject vehicle turns, has been well known. As an exemplary technology to realize such the functions, the headlight is frequently provided with a plurality of light-emitting chips such as a light-emitting diode (LED). The headlight may selectively emit light on a respective one of light-emitting regions corresponding to each of the light-emitting chips by individually turning on/off each of the light-emitting chips.

An LED lighting apparatus, which may individually control each of on-off actions of the plurality of light emitting chips, is, for example, disclosed Patent Document No. 1 (Japanese Patent Application Laid Open No. 2009-134, 933). FIG. 9a is a block diagram of an LED lighting apparatus including a plurality of LEDs used for a conventional headlight, which is disclosed in Patent Document No. 1. FIGS. 9b and 9c are a top view and a side view depicting an LED module having a matrix arrangement of the LEDs disclosed in Patent Document No. 1, respectively.

The conventional LED lighting apparatus 80 discloses: a constant current source 82; a plurality of LEDs D1, D2, D3 and Dn connecting in series with the constant current source 82; a plurality of switching devices Q1, Q2, Q3 and Qn each having a gate, a source and a drain, and each of the sources and the drains of the switching devices Q1, Q2, Q3 and Qn connected in parallel with a respective one of the LEDs D1, D2, D3 and Dn, respectively; and an LED controller 81 connecting to each of the gates of the switching devices Q1, Q2, Q3 and Qn so as to be able to turn on/off the respective one of the LEDs D1, D2, D3 and Dn.

Accordingly, the conventional LED lighting apparatus 80 may uniform each of light intensities of the LEDs D1, D2, D3 and Dn by adjusting each of on-off ratios of the LEDs D1, D2, D3 and Dn while the conventional LED lighting apparatus 80 emits lights from the LEDs D1, D2, D3 and Dn by using a Pulse Width Modulation (PWM) drive method. In this case, the lights emitted from the LEDs D1, D2, D3 and Dn may become surface-emitted by using the LEDs D1, D2, D3 and Dn as an LED module 84 having a matrix arrangement DM, in which each of the LEDs D1, D2, D3 and Dn is mounted on a base board 85.

Patent Document No. 1 also discloses that a conventional headlight may provide light distribution patterns such as a high beam, a low beam, a day light running lights (DRL), an adaptive front-lighting system (AFS) for emitting light in a steering angle direction of the subject vehicle, etc. using the LED module 84, which is shaped in the matrix arrangement DM, as a light source for the headlight including the LED lighting apparatus 80. The headlight including the LED lighting apparatus 80 may need a plurality of serial circuits to shape in the matrix arrangement DM because of using many LEDs. Additionally, the conventional LED lighting apparatus 80 may need the many switching devices the same number as the many LEDs. Hence, the conventional headlight should be subject to a complex structure.

In addition, when each of the LEDs is emitted in the above-described structure, each of maximum forward voltages of the LEDs may be approximately 4 volts. Accordingly, when the plurality of the LEDs connects in series, a driving LED voltage may be higher in proportion as the number of the LEDs. However, there is a limit o the supply capability in a circuit and the like for supplying the driving LED voltage, and therefore generally, the upper limit number of the light-emitting chips connectable in series may be approximately 12.

In order to connect more light-emitting chips, because it is necessary to use a circuit and the like having a higher breakdown voltage, each of costs of parts may greatly increase. On the other hand, to avoid the use of such expensive parts, for example, when the upper limit number of the light-emitting chips connectable in series is the 12, if the number of light-emitting ships exceeds this upper limit by even one, it may be necessary to further increase the circuit and the like for supplying a driving voltage between the LEDs D1 and Dn. Therefore, the conventional LED apparatus 80 may cause disadvantages such as the parts cost rises and a space saving thereof hinders, because the lighting configuration also becomes large.

Moreover, when the LED apparatus 80 includes many LEDs having a low light-intensity in the LEDs D1 to Dn, because the LED apparatus 80 may tend to apply a large current to the LEDs, the conventional LED apparatus 80 may also cause defects such that exceed the supply capability of the driving voltage.

The above-referenced Patent Documents is listed bellow and is hereby incorporated with its abstract in its entirety.

1. Patent Document No. 1: Japanese Patent Application Laid Open No. 2009-134,933

The present invention has been devised to consider the above and other problems, characteristics and features. Thus, exemplary embodiments of the present invention can include control apparatuses of a light source including a plurality of light-emitting chips connected in series, and the control apparatus can also include a plurality of switching devices each connected in parallel with a respective one of the light-emitting chips. The control apparatus can allow the switching devices to decrease than the number of the light-emitting chips, and also can selectively emit light from the respective one of the light-emitting chips so as to become a lower driving voltage than a driving voltage of cases where all the light-emitting chips are turned on. Accordingly, the exemplary embodiments of the present invention can include vehicle lamps using the control apparatus, which can provide preferable light distribution patterns with reliability and a simple structure in accordance with road conditions, and which can be used as a headlight, a cornering lamp, a rear combination lamp, etc.

### SUMMARY

The presently invention has been devised in view of the above and other characteristics, desires, and problems in the conventional art. An aspect of the present invention can include reliable control apparatuses for controlling on-off actions of a light source having a plurality of light-emitting chips connected in series, which may selectively emit light form each of the light-emitting chips so as to become a lower serial driving voltage. Another aspect of the present invention can include providing vehicle lamps using the control apparatus, which can provide preferable light distribution patterns with reliability and a simple structure in accordance with road conditions.

According to an aspect of the present invention, an exemplary control apparatus for controlling on-off states of a light source provided with a plurality of light-emitting chips, can include: a plurality of switching devices each connected in parallel with a respective one of the light-emitting chips; a current supply unit applying a driving current to the serial circuit of the light source; and a control circuit connected to each of gates of the switching devices, and controlling each of on-off actions of the switching devices, wherein the control circuit turns on at least one of the switching devices, which connect in parallel with at least one of the light-emitting chips, when the number of the light-emitting chips is N, and when the current supply unit applies the driving current to the light-emitting chips of the number N−1 or less of light-emitting chips at the same time.

In the above-described exemplary control apparatus, the control apparatus can control the at least one of the light-emitting chips in a state of the off action using the at least one of the switching devices by selectively cutting off each of the light-emitting chips every a respective one of exclusive times in a light-emitting cycle of the light-emitting chips.

According to the above-described exemplary control apparatuses, the control circuit can selectively emit each of the light-emitting chips so as to become a lower driving voltage than a driving voltage of cases where all the light-emitting chips are emitted, and also the control apparatus including the control circuit can allow the switching devices to decrease than the number of the light-emitting chips when the control apparatus need not necessarily to include the same number of the switching devices as the light-emitting chips. Thus, the present invention can provide the control apparatuses for controlling the on-off actions of the light source having the plurality of light-emitting chips connected in series with reliability and a simple structure as compared to a parallel circuit of the light-emitting chips.

According to another aspect of the present invention, an exemplary vehicle lamps using the control apparatus can further include a system controller for controlling the control apparatus of the light source. The system controller can include: an angle signal input receiving a steering angle signal from the subject vehicle; a switch signal input receiving switch data such as a high beam mode, a low beam mode and the like of a headlight; and a light-emitting signal output outputting a light-emitting control signal to the control circuit of the control apparatus. Thereby, the control circuit can selectively turn on each of the light-emitting chips while maintaining the driving voltage of the light-emitting chips at a lower voltage.

According to the exemplary vehicle lamp using the control apparatus, the system controller can output a light-emitting control signal from a light-emitting signal output to the control circuit. Thus, the present invention can provide the vehicle lamps using the control apparatus, which can provide preferable light distribution patterns with reliability and a simple structure in accordance with road conditions, and which can be used as usage such as a headlight, a cornering lamp, etc.

### BRIEF DESCRIPTION OF THE DRAWINGS

These and other characteristics and features of the present invention will become clear from the following description with reference to the accompanying drawings, wherein:

FIG. 1 is a block diagram showing an exemplary embodiment of a vehicle lamp made in accordance with principles of the present invention;

FIG. 2a is an explanatory front view of exemplary light distribution embodiments provided by a headlight when the vehicle lamp of FIG. 1 is used as the headlight, FIG. 2b is an explanatory top view showing light distribution patterns emitted from each of the light-emitting chips of a light source of the present invention, and FIG. 2c is a top cross-sectional view showing an exemplary embodiment of a cornering lamp using the light-emitting chips of FIG. 2b;

FIGS. 3a to 3c are explanatory top views for explaining exemplary light distribution patterns formed by the light-emitting chips of FIG. 2b;

FIG. 4 is an exemplary timing chart showing variations of the exemplary light distribution patterns shown in FIG. 3a to FIG. 3c;

FIG. 5 is an explanatory partial circuit for explaining an exemplary variation of the exemplary embodiment of the vehicle lamp shown in FIG. 1;

FIG. 6 is a timing chart showing an exemplary on-off states of each of the light-emitting chips when a control circuit drives each of the light-emitting chips using a pulse width modulation drive method;

FIG. 7 is a block diagram showing another exemplary embodiment of the vehicle lamp made in accordance with principles of the present invention;

FIG. 8 is a front view showing an exemplary variation of the cornering lamp shown in FIG. 2c; and

FIG. 9a is a block diagram showing a conventional LED lighting apparatus including a plurality of LEDs connected in series, and FIGS. 9b and 9c are a top view and a side view depicting an LED module having a matrix arrangement of the LEDs, respectively.

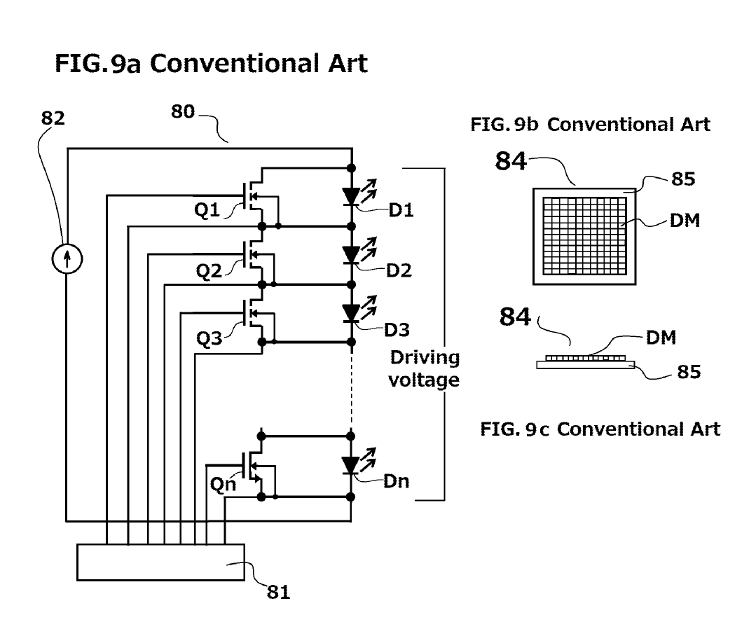

### DETAILED DESCRIPTION OF EXEMPLARY EMBODIMENTS

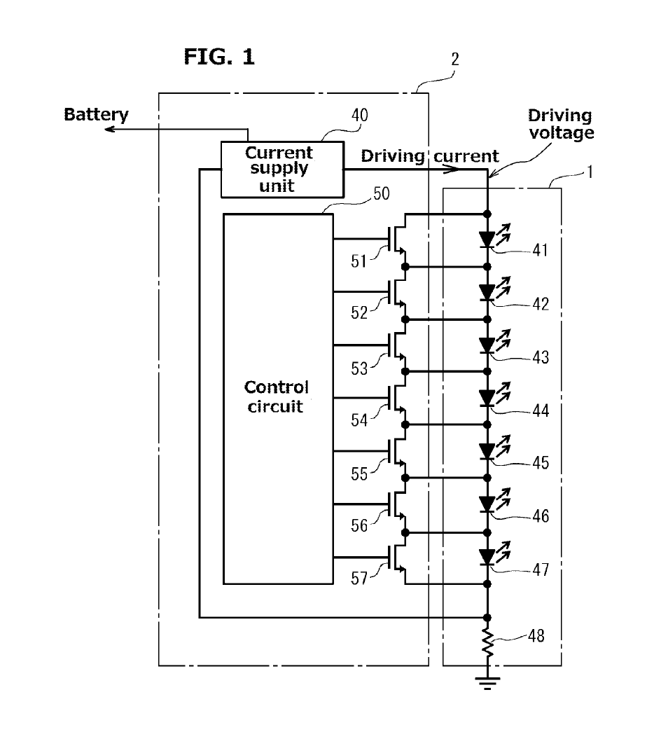

The present invention will now be described in detail with reference to FIG. 1 to FIG. 8, in which the same, similar, or corresponding elements use the same reference marks. FIG. 1 is a block diagram showing an exemplary embodiment of a vehicle lamp made in accordance with principles of the present invention. The vehicle lamp can include: a light source 1 including seven light-emitting chips 41, 42, 43, 44, 45, 46 and 47 connected in series and a resistor 48 connected in series with the light-emitting chips 41-47; and a control apparatus 2 for controlling an on-off action of the light source 1.

The control apparatus 2 can include: a current supply unit 40; a control circuit 50; and seven switching devices 51, 52, 53, 54, 55, 56 and 57, each of the switching devices 51 to 57 having a source (S), a drain (D) and a gate (G). The current supply unit 40 can generate a drive voltage by using a battery power supply (BPS) as a voltage supply, and can apply a driving current to each of the light-emitting chips 41-47 by applying the above drive voltage to the light-emitting chips 41-47 of the light source 1 as shown in FIG. 1. The control circuit 50 can connect to each of the gates (G) of the switching devices 51 to 57, and can turn on each of current channels between the sources (S) and the drains (D) of the switching devices 51 to 57 by apply an on signal to each of the gates (G) of the switching devices 51 to 57.

Each of the current channels between the sources (S) and the drains (D) of the switching devices 51 to 57 can be connected in parallel with a respective one of the light-emitting chips 41 to 47, and the respective one of the gates (G) of the switching devices 51 to 57 can connect the control circuit 50. Accordingly, the control circuit 50 can control each of on-off states of the switching devices 51 to 57 by applying a control signal to the respective one of the gates (G) of the switching device 51 to 57.

For example, when the control circuit 50 controls the switching device 51 so as to become the on state, because the control circuit 50 can divert the driving current applied to the light-emitting chip 41 to the current channel between the source (S) and the drain (D) of the switching device 51, the control circuit 50 can turn off the light-emitting chip 41. A relation of on-off state between each of the other switching devices 52 to 57 and a respective one of the light-emitting chips 42 to 47 connected in parallel with each of the other switching devices 52 to 57 can also be similar.

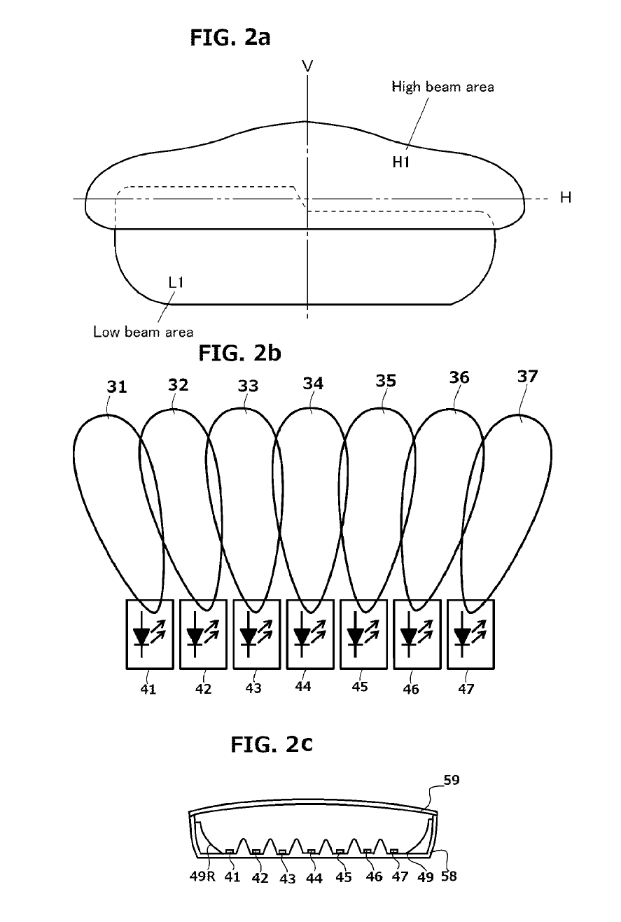

FIG. 2a is an explanatory front view showing exemplary light distribution embodiments when the vehicle lamp of the present invention is used as a headlight, and FIG. 2b is an explanatory top view showing light distribution patterns emitted from each of the light-emitting chips 41 to 47 of the light source 1 of the present invention. The vehicle lamp can provide light distribution patterns on a low beam area L1 and a high beam area H1 with reference to a horizontal line H and a vertical line V when the vehicle lamp is used as the headlight.

In each of the light distribution patterns 31 to 37 shown in FIG. 2b, the light distribution pattern 34 emitted from the light-emitting chip 44 can be formed in a middle portion (near the vertical line V) of a horizontal direction with respect to a road. Each of the light distribution patterns 33 and 35 emitted from the light-emitting chip 43 and 45, which are located adjacent to the light-emitting chip 44, can be formed so as to lean in an opposite direction with reference to the light distribution 34, which is located in a central direction of the light distribution patterns 31 to 37.

The light distribution pattern 32 emitted from the light-emitting chip 42, which is located adjacent to the light-emitting chip 43, can be formed so as to further incline in an opposite direction toward the light distribution pattern 33, and the light distribution pattern 31 emitted from the light-emitting chip 41, which is located adjacent to the light-emitting chip 42, can be formed so as to further incline in the opposite direction toward the light distribution pattern 32. Similarly, the light distribution pattern 36 emitted from the light-emitting chip 46, which is located adjacent to the light-emitting chip 45, can be formed so as to further incline in an opposite direction toward the light distribution pattern 35, and also the light distribution pattern 37 emitted from the light-emitting chip 47, which is located adjacent to the light-emitting chip 46, can be formed so as to further incline in the opposite direction toward the light distribution pattern 36.

In addition, each of the adjacent light distribution patterns of the light distribution patterns 31 to 37 can partially overlap with respect to each other. In this case, the control circuit 50 can provide a high beam using the light distribution patterns 31-37, which are emitted from each of the light-emitting chips 41 to 47. FIG. 2b shows a case where the control circuit 50 turns on all the light-emitting chips 41 to 47. However, the control circuit 50 can turn off a part of the light-emitting chips 41 to 47 in accordance with road conditions as described later.

The vehicle lamp, which is structured to use the light source 1 provided with the above-described seven light-emitting chips 41 to 47, can include: the seven light-emitting chips 41 to 47 aligning in the horizontal direction, and arranged so that a light-emitting direction thereof becomes a downward direction; a lamp unit 49 including a reflector 49R having seven parabolic surfaces, the reflector 49R located in an opposite direction of the light-emitting direction of light-emitting chips 41 to 47; a casing 58 having an opening incorporating the reflector 49R; and a transparent cover 59 attached to the opening of the casing 58 as shown in FIG. 2c. The vehicle lamp can operate as a corning lamp when turning along a curve road, and can form the light distribution pattern in a frontward direction of the subject vehicle when not turning.

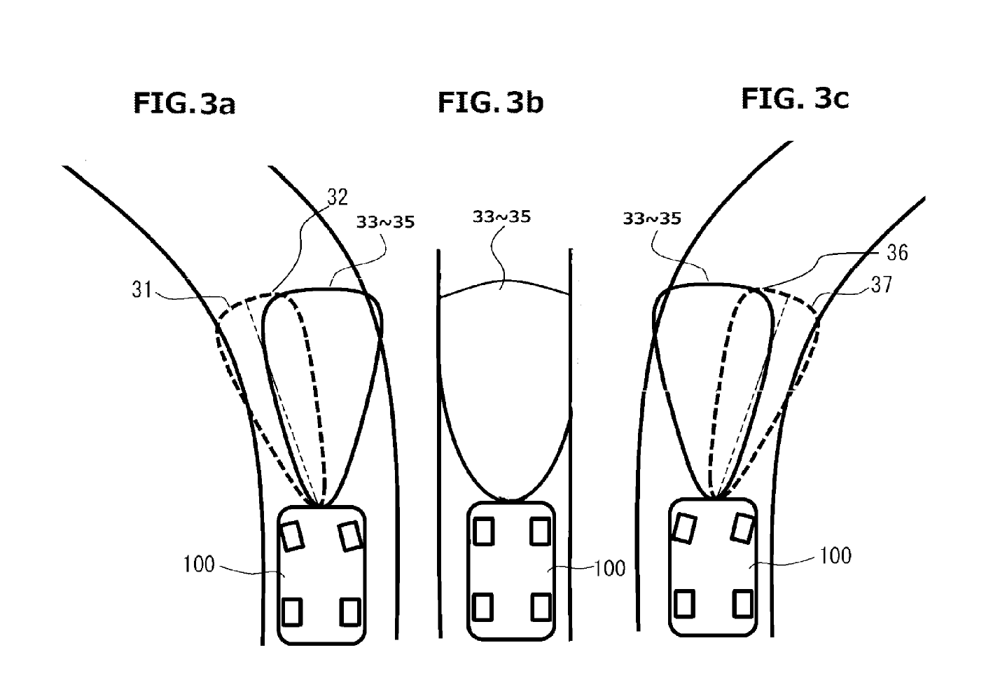

FIGS. 3a to 3c show exemplary light distribution patterns formed by the vehicle lamp using the light source 1 when the vehicle 100 is driven on a left-hand curve road, a straight road and a right-hand curve road, respectively. The subject vehicle 100 incorporating the headlight, which is provided with the light-emitting chips 41 to 47 as the light source 1, can selectively form each of the light distribution patterns 31 to 37 in the frontward direction thereof. In these cases, the high beam can be formed by the light distribution patterns 33 to 35 when the control apparatus 2 turns on each of the light-emitting chips 43 to 45 as shown in FIG. 3b. Additionally, each of the light-emitting chips 41 to 47 may selectively be turned off in accordance with a position of another vehicle, which is located in the frontward direction of the subject vehicle 100.

When the subject vehicle 100 is driven on the left-hand curve road, the control apparatus 2 can provide each of the light distribution patterns 32 to 31 in two stages along the left-hand curve road by serially turning on each of the light-emitting chips 42 and 41 in addition to the light distribution patterns 33 to 35. When the subject vehicle 100 is driven on a straight road, only each of the light-emitting chips 43, 44 and 45 turns on, and therefore the control apparatus 2 can form only each of the light distribution patterns 33 to 35 as the continuous light distribution patterns in the middle forward direction of the subject vehicle 100.

When the subject vehicle 100 is driven on the right-hand curve road, the control apparatus 2 can provide each of the light distribution patterns 36 to 37 in two stages along the right-hand curve road by serially turning on each of the light-emitting chips 46 and 47 in addition to the light distribution patterns 33 to 35. Accordingly, because each of the light-emitting chips 41 and 47 may become paired in one stage, when one of the light-emitting chips 41 and 47 is turned on, another of the light-emitting chips 41 and 47 cannot be turned on. Each of the light-emitting chips 42 and 46 can also become paired in the two stages as described above.

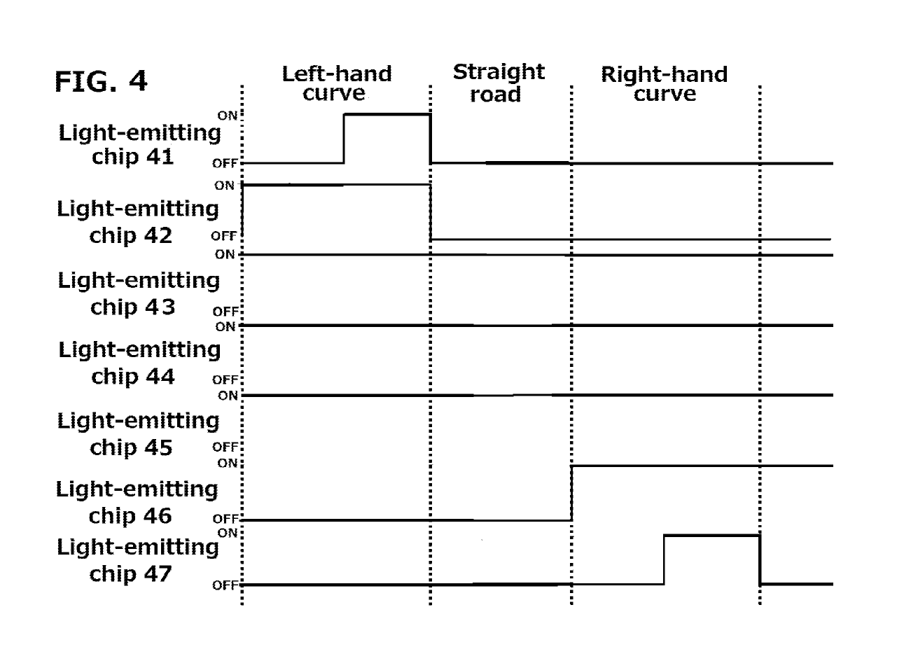

FIG. 4 is an exemplary timing chart showing variations of the light distribution patterns shown in FIG. 3a to FIG. 3c. When the subject vehicle 100 is turned from the straight road to the left-hand curve road, the control apparatus 2 can turn on the light-emitting chip 42 forming the light distribution pattern 32, and can turn on the light-emitting chip 41 forming the light distribution pattern 31 in the two stages along the left-hand curve road by serially turning on each of the light-emitting chips 41 and 42 in addition to the light distribution patterns 33 to 35.

When the subject vehicle 100 is returned on the straight road, only each of the light-emitting chips 43, 44 and 45 turns on, and therefore the control apparatus 2 can form only each of the light distribution patterns 33 to 35 as the continuous light distribution patterns in the middle forward direction of the subject vehicle 100. When the subject vehicle 100 is driven toward the right-hand curve road, the control apparatus 2 can provide each of the light distribution patterns 36 to 37 in two stages along the right-hand curve road by serially turning on each of the light-emitting chips 46 and 47 in addition to the light distribution patterns 33 to 35.

Therefore, because the control apparatus 2 turns on only five light-emitting chips at the peak of emissions of the light-emitting chips 41 to 47, the control apparatus 2 can last if it is capable of applying the driving current to only five light-emitting chips. Thus, the present invention can provide the control apparatus 2 having a high reliability for controlling on-off actions of many light-emitting chips connected in series. Additionally, because the above-described light-emitting chips 41 to 47 can be connected in series, the control apparatus 2 having a high reliability can become a simple structure as compared to a parallel circuit of the light-emitting chips.

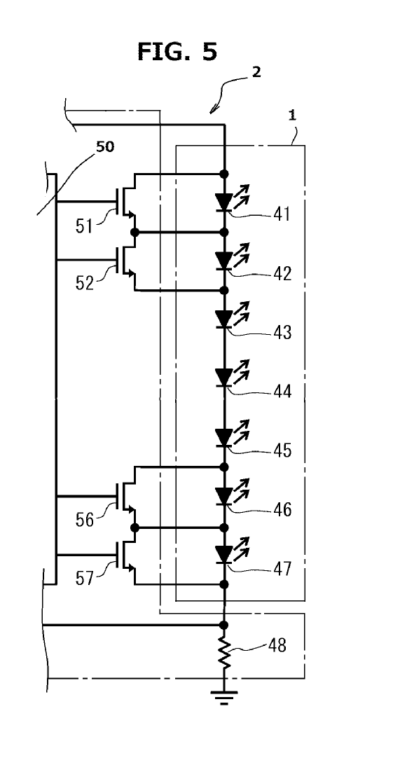

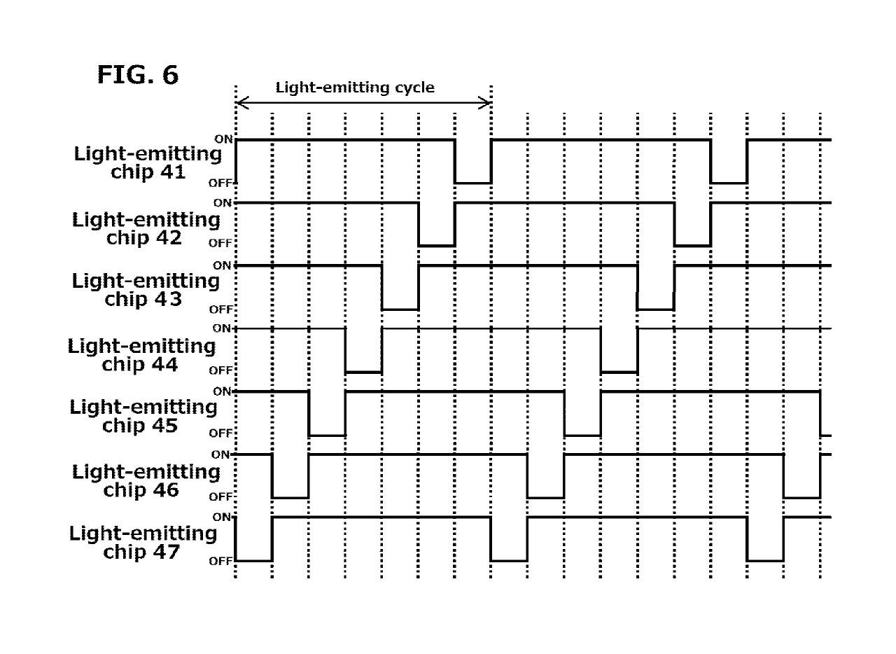

Moreover, when the control apparatus 2 may fix the light distribution patterns 33 to 35 as the continuous fixed light distribution patterns, because the control circuit 50 need not to turn on/off each of the light-emitting chips 43 to 45, the switching devices 53 to 55 can be removed from the control apparatus 2 as shown in FIG. 5. FIG. 6 is a timing chart showing an exemplary on-off states of each of the light-emitting chips 41 to 47 when the control circuit 50 drives each of the light-emitting chips 41 to 47 using a pulse width modulation (PWM) drive method.

The control circuit 50 can control each of the switching devices 51 to 57 so that at least one of the light-emitting chips 41 to 47 is turned off at a light-emitting interval in order to maintain a lower driving voltage than the driving voltage when all the light-emitting chips 41 to 47 are emitted in operation. More specifically, according to the exemplary embodiment of the present invention, the light-emitting interval can be a time in which a light-emitting cycle is divided by the number N of the light-emitting chips 41 to 47 or more. The light-emitting cycle can be divided by seven(the number N=7), and he light-emitting cycle can include seven light-emitting intervals as shown in FIG. 6. The control circuit 50 can controls each of the light emitting chips 41 to 47 so that any one of the light-emitting chips 41 to 47 is always turned off exclusively in the seven interval of the light-emitting cycle.

That is, an off time for turning off each of the light-emitting chips 41 to 47 cannot be overlapped. Each of the light emitting chips 41 to 47 can be controlled by the control circuit 50 so that the light-emitting chip 47 is turned off in a first interval, the light-emitting chip 46 is turned off in a second interval, the light-emitting chip 45 is turned off in a third interval, the light-emitting chip 44 is turned off in a fourth interval, the light-emitting chip 43 is turned off in a fifth interval, the light-emitting chip 42 is turned off in a sixth interval, and the light-emitting chip 41 is turned off in a seventh interval, respectively.

When each of the light-emitting chips 41 to 47 is turned on in other intervals other than the interval set to be turned off, the control circuit 50 can control the respective one of the switching devices 51 to 57, which is connected in parallel with each of the light-emitting chips 41 to 47, such that turns off, and also can control the respective one of the switching chips 51 to 57 such that turns on when each of the light-emitting chips 41 to 47 is turned off in the other intervals other than the interval set to be turned off. It is preferable to set the light-emitting cycle at, for example, 5 milliseconds (ms) or less. The reason will be explained below.

In general, it is known that it is recognized that a human is blinking in a continuous lighting state without being perceived when a light-emitting chip is blinked at a cycle of 5 milliseconds (ms) or less. For example, when the number of light-emitting chips is N, when a brightness of the light-emitting chip is proportional to a current, the light-emitting chip can maintain the brightness thereof by setting the current to N/(N−1) times and a ratio of the lighting time to the extinction time to (N−1)/N times and by setting the blinking cycle at 2 ms or less, and it seems that the number N of the light-emitting chips are all lit at the same time.

At this time, because the number of the light-emitting chips to which a current is injected is (N−1), the control apparatus 2 can decrease a required maximum voltage. When using an LED as a light-emitting chip, for example, when the number of the LED is seven, a current, which is applied to the LEDs, can be made 7/6 times. Thereby, the above-described driving method can enable the control apparatus 2 to drive six LEDs at the same time while keeping a brightness of the seven LEDs by repeating on-off actions based on the timing chart as shown in FIG. 6.

When the current applied to the light-emitting chips is 7/6 times, an increment ΔVf of the forward voltage per one light-emitting chip can be expressed as follows. ΔVf=(nkT/q)×1n(7/6) . In this case, n is diode factor, K is Boltzmann constant, T is absolute temperature, and q is elementary charge. When n is 3 and T is 30 kelvin (approximately 27 degrees centigrade), ΔVf may become 12 millivolts. When a forward voltage of the light-emitting chip is 3 volts, this increment ΔVf is only 0.4 percent (%) and the influence on the maximum voltage required for the control apparatus 2 may be very minor.

When the number of the light-emitting chips to be controlled is larger, such control may become particularly effective. When a hundred light-emitting chips are controlled independently by one drive circuit, and when the driving voltage applied to one light-emitting chip is 10 times and each of the light-emitting chips is turned on as 1/10, the increment of the driving voltage may become ΔVf=179 mV in accordance with the above-described formula. When the forward voltage of the light-emitting chip is 3 volts, the increment ΔVf of the driving voltage may be only about 6% of the forward voltage.

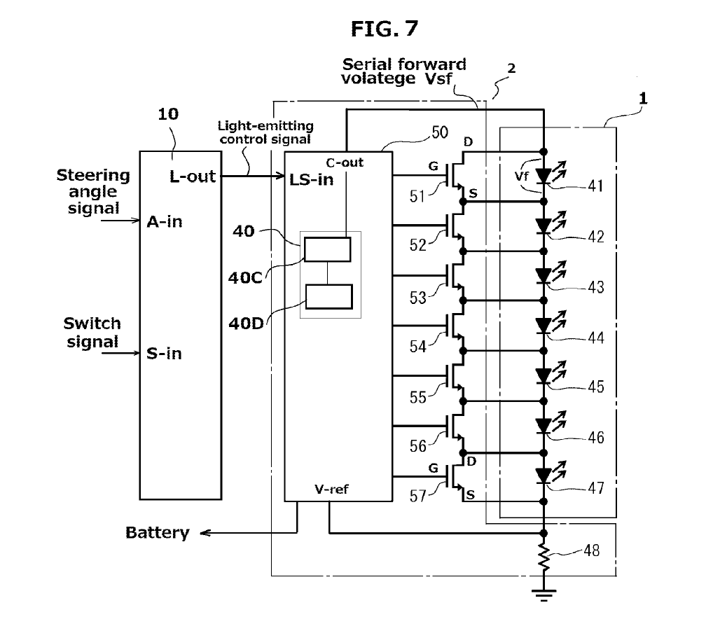

Therefore, even if the number of light-emitting chips is a hundred, because an average current given per one light-emitting chip is approximately 1/10, the control apparatus 2 can independently drive each of 100 light-emitting chips without increasing the number of drive circuits. That is, the present invention can prevent an increase in the number of drive circuits by increasing a peak value of the current applied to the light-emitting chip and decreasing a ratio of one-off times. Next, when the vehicle lamp is used as the cornering lamp shown in FIG. 2c, another exemplary embodiment will now be described with reference to FIG. 7.

When a rated voltage of the battery is 12 volts, a supply voltage of the battery need to be pressured because seven light emitting chips 41 to 47 connected in series are driven. Accordingly, the supply voltage of the battery can be boosted by a DC-DC converter 40D, and a constant current circuit 40C can apply a constant current to each of the light-emitting chips 41 to 47 through said boosted voltage from a current output C-out by incorporating the converter 40D and the constant current circuit 40C into the current supply unit 40.

The vehicle lamp can also include a system controller 10 including: an angle signal input A-in receiving a steering angle signal from the subject vehicle 100; a switch signal input S-in receiving switch data such as a high beam mode, a low beam mode and the like; and a light-emitting signal output L-out outputting a light-emitting control signal to a light-emitting signal input LS-in of the control circuit 50. Thereby, the control circuit 50 can selectively turn on each of the light-emitting chips 41 to 47 while maintaining a serial forward voltage Vsf of the light-emitting chips 41 to 47 at a lower voltage than a total voltage of each of forward voltages Vf of the light-emitting chips 41 to 47.

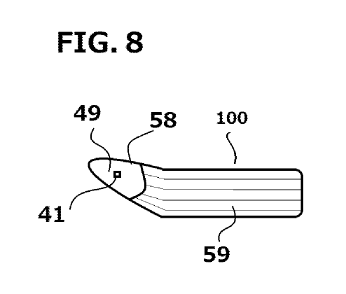

Therefore, the control apparatus 2 can form the preferable light distribution patterns as shown in FIG. 3a to FIG. 3c as the cornering lamp in accordance with the light-emitting control signal. In addition, the cornering lamp can be incorporated into a rear left and/or a rear right of the subject vehicle 100 as shown in FIG. 8. The cornering lamp can also be used to emit the lights from the light-emitting chips 41 to 47 in a rearward direction when the subject vehicle 100 goes in reverse.

The present invention cannot be limited to contents of the above-described embodiments, and various modifications can be made within the scope of gist of the present invention. For example, in the above-described embodiment, cases where the present invention is applied to a vehicle lamp used for a right and left variable light distribution n the subject vehicle are described. However, the present invention can also be applied to a vehicle lamp used for variable light distribution in the vertical direction of the subject vehicle.

Moreover, in the above-described embodiments, the number of the light-emitting chips, which can be individually the on-off actions, can be increased by one light-emitting chip by setting the average lighting rate per one light-emitting chip at [(N−1)/N] or less. However, when the current injected into the light-emitting chips has leeway, it is also possible to increase the number of serial connection of the light-emitting chips by two or more by decreasing the average lighting rate while increasing the forward current.

Various modifications of the above disclosed embodiments can be made without departing from the spirit and scope of the presently disclosed subject matter. For example, cases where FET is used as each of the switching elements are described. However, each of the switching elements is not limited to the FET, and a transistor and the like can also be used such as each of the switching elements. In addition, the specific arrangement between components can vary between different applications, and several of the above-described features can be used interchangeably between various embodiments depending on a particular application of the headlight system including the headlight controller.

While there has been described what are at present considered to be exemplary embodiments of the invention, it will be understood that various modifications may be made thereto, and it is intended that the appended claims cover such modifications as fall within the true spirit and scope of the invention. All conventional art references described above are herein incorporated in their entireties by reference.

What is claimed is:

1. A control apparatus for controlling on-off states of a light source provided with a plurality of light-emitting chips connected in series, comprising: a plurality of switching devices each connected in parallel with a respective one of the light-emitting chips: a current supply unit applying a driving current to a serial circuit of the plurality of light-emitting chips; and a control circuit controlling each of on-off states of the switching devices, wherein the control circuit turns off at least one of the switching devices, which connect in parallel with at least one of the light-emitting chips, when the number of the light-emitting chips is N, and when the control circuit controls an on state of each of the switching devices connected in parallel with a respective one of the number N−1 or less of the light-emitting chips.

2. The control apparatus according to claim 1, wherein the control circuit controls not to substantially applying the driving current to the at least one of the light-emitting chips by diverting the driving current, which is applied to the at least one of the light-emitting chips, to a different current channel from that applied to the at least one of the light-emitting chips.

3. The control apparatus according to claim 2, wherein when the control circuit turns on one of at least one pair of light-emitting chips in the light-emitting chips, the control circuit controls not to applying the driving current to the at least one of the light-emitting chips by cutting off the driving current applied to another of the at least one pair of light-emitting chips in the light-emitting chips when the control circuit apples the driving current to the number N−1 or less of the lighting chips at the same time.

4. The control apparatus according to claim 2, wherein when the control circuit applies the driving current to one of light-emitting chips located at both ends of the plurality of light-emitting chips, the control circuit controls not to substantially apply the driving current to the at least one of the light-emitting chips by cutting off the driving current to another of the light-emitting chips located at the both ends of the plurality of the light-emitting chips when applying the driving current to the respective one of the number N−1 or less of the light-emitting chips at the same time.

5. The control apparatus according to claim 1, wherein the control circuit controls not to substantially applying the driving current to the at least one of the light-emitting chips by selectively cutting off the respective one of the light-emitting chips every a respective one of exclusive times in a light-emitting cycle of the light-emitting chips when the control circuit apples the driving current to the number N−1 or less of the lighting chips at the same time.

6. The control apparatus according to claim 2, wherein the control circuit controls not to substantially applying the driving current to the at least one of the light-emitting chips by selectively cutting off the respective one of the light-emitting chips every a respective one of exclusive times in a light-emitting cycle of the light-emitting chips when the control circuit apples the driving current to the number N−1 or less of the lighting chips at the same time.

7. The control apparatus according to claim 5, wherein the respective one of the exclusive times is an interval in which the light-emitting cycle is divided by the number N or more.

8. The control apparatus according to claim 5, wherein the light-emitting cycle is 5 millisecond or less.

9. The control apparatus according to claim 7, wherein the light-emitting cycle is 5 millisecond or less.

10. A control apparatus for controlling on-off states of a light source having the number N of a plurality of light-emitting chips connected in series, comprising a control circuit applying a constant current as a driving circuit of the light source to the serial circuit of the light source in operation, wherein the control circuit turns off at least one of switching devices, which connect in parallel with at least one of the light-emitting chips when the control circuit apples the constant current to the number N−1 or less of the light-emitting chips at the same time.

11. A vehicle lamp using the control apparatus according to claim 1, further comprising a system controller outputting a light-emitting control signal to the control apparatus, wherein the control apparatus controls the light source in accordance with the light-emitting control signal.

12. A vehicle lamp using the control apparatus according to claim 2, further comprising a system controller outputting a light-emitting control signal to the control apparatus, wherein the control apparatus controls the light source in accordance with the light-emitting control signal.

13. A vehicle lamp using the control apparatus according to claim 10, further comprising a system controller outputting a light-emitting control signal to the control apparatus, wherein the control apparatus controls the light source in accordance with the light-emitting control signal.

14. The vehicle lamp using the control apparatus according to claim 11, wherein the light source is provided with three or more light-emitting diodes (LED), which connect in series and align in a vertical direction with reference to a road, wherein when the control apparatus turns on one of the LEDs located at both ends of the three or more LEDs, the control apparatus turns off another of the LEDs located at the both ends of the three or more LEDs.

15. The vehicle lamp using the control apparatus according to claim 12, wherein the light source is provided with three or more LEDs, which connect in series and align in a vertical direction with reference to a road, wherein when the control apparatus turns on one of the LEDs located at both ends of the three or more LEDs, the control apparatus turns off another of the LEDs located at the both ends of the three or more LEDs.

16. The vehicle lamp using the control apparatus according to claim 13, wherein the light source is provided with three or more LEDs, which connect in series and align in a vertical direction with reference to a road, wherein when the control apparatus turns on one of the LEDs located at both ends of the three or more LEDs, the control apparatus turns off another of the LEDs located at the both ends of the three or more LEDs.
